(19) United States
(12) Patent Application Publication
(10) Pub. No.: US 2013/0070945 A1
(43) Pub. Date: Mar. 21, 2013

(54) HEARING AID DEVICE AND AUDIO CONTROL METHOD

(71) Applicants: Kazue Fusakawa, Kanagawa (JP); Gempo Ito, Kanagawa (JP); Takashi Katayama, Ehime (JP)

(72) Inventors: Kazue Fusakawa, Kanagawa (JP); Gempo Ito, Kanagawa (JP); Takashi Katayama, Ehime (JP)

(21) Appl. No.: 13/582,576

(22) PCT Filed: Mar. 15, 2012
(86) PCT No.: PCT/JP2012/001831

§ 371 Date: Sep. 4, 2012

(30) Foreign Application Priority Data
Mar. 18, 2011 (JP) 2011-060220

(51) Int. Cl. H04R 25/00

(52) U.S. Cl. CPC H04R 25/00
USPC 381/312

(57) ABSTRACT

The hearing aid makes conversation sound easier to hear. The hearing aid device (100) comprises a first audio controller (40) that receives a center signal (C), a left-front signal (L), a right-front signal (R), a left-rear signal (SL), and a right-rear signal (SR), and second audio controller (20) that receives the output signal from the first audio controller (40). The first audio controller (40) has a sound image localization processor (42) that locates a sound image in a specific direction with respect to the left-front signal (L), the right-front signal (R), the left-rear signal (SL), and the right-rear signal (SR). The second audio controller (20) has a first amplifier (21) that amplifies the output signal from the sound image localization processor (42), and a hearing aid processor (22) that amplifies the center signal (C) according to the hearing ability of the user of the hearing aid device (100), and outputs the output signal from the first amplifier (21) and the output signal from the hearing aid processor (22) as sound.

### TECHNICAL FIELD

The present invention relates to a hearing aid device and an audio control method for listening to a television broadcast or the like.

### BACKGROUND ART

A conventional hearing aid device was constituted as follows. Specifically, it comprised an audio controller that processed TV broadcasts for hearing aid use, and a hearing aid that was supplied with the output from the audio controller. The hearing aid. had a hearing aid processor and a receiver (speaker). Technology similar to this is discussed in the following Patent Literature 1.

### CITATION LIST

### Patent Literature

Patent Literature Japanese Laid-Open Patent Application 2010-246121

### SUMMARY

### Technical Problem

With a conventional hearing aid device, it was sometimes difficult to hear conversation sound in a TV program, The reason for this is as follows. Most modern TV broadcasts are supplied with at least a five-channel signal consisting of a center signal (C), a left-front signal (L), a right-front signal (R), a left-rear signal (SL), and a right-rear signal (SR) in order to provide a more authentic sound. If these signals are supplied directly to a hearing aid, conversation sound may become masked in ambient sounds, the result being that the conversation is harder to hear.

In view of this, it is an object of the present invention to make conversation sound in a TV program easier to hear with a hearing aid.

### Solution to Problem

One aspect of the present invention is a hearing aid device that outputs sound on the basis of a plurality of audio signals, including at least a center signal, a left-front signal., a right-front signal, a left-rear signal, and a right-rear signal, said hearing aid device comprising a first audio controller configured to receive the center signal, the left-front signal, the right-front signal, the left-rear signal, and the right-rear signal, and a second audio controller configured to receive an output signal from the first audio controller. The first audio controller has a sound image localization processor configured to locate a sound image in a specific direction with respect to the left-front signal, the right-front signal, the left-rear signal, and the right-rear signal. The second audio controller has a first amplifier configured to amplify the output signal from the sound image localization processor, and a hearing aid processor configured to amplify the center signal according to a. hearing ability of a user of the hearing aid device, and the second audio controller outputs an output signal from the first amplifier and an output signal from the hearing aid processor as sound.

### Advantageous Effects

The present invention makes it easier to hear conversation sound in a TV program with a bearing aid.

### BRIEF DESCRIPTION OF DRAWINGS

FIG. 1 is an oblique view of a hearing aid device pertaining to one embodiment of the present invention;

FIG. 2 is a control block diagram of the hearing aid device;

FIG. 3 is a control block diagram of the main components of the hearing aid device;

FIG. 4 is a control block diagram of the main components of the hearing aid device;

FIG. 5A is a diagram illustrating the operation in sound image localization processing by the hearing aid device;

FIG. 5B is a diagram illustrating the operation in sound image localization processing by the hearing aid device;

FIG. 5C is a diagram illustrating the operation in sound image localization processing by the hearing aid device; and

FIG. 5D is a diagram illustrating the operation in sound image localization processing by the hearing aid device.

### DESCRIPTION OF EMBODIMENTS

One embodiment of the present invention will now be described in detail through reference to the drawings.

### 1. Embodiment

### 1.1 Hearing Aid Device 100

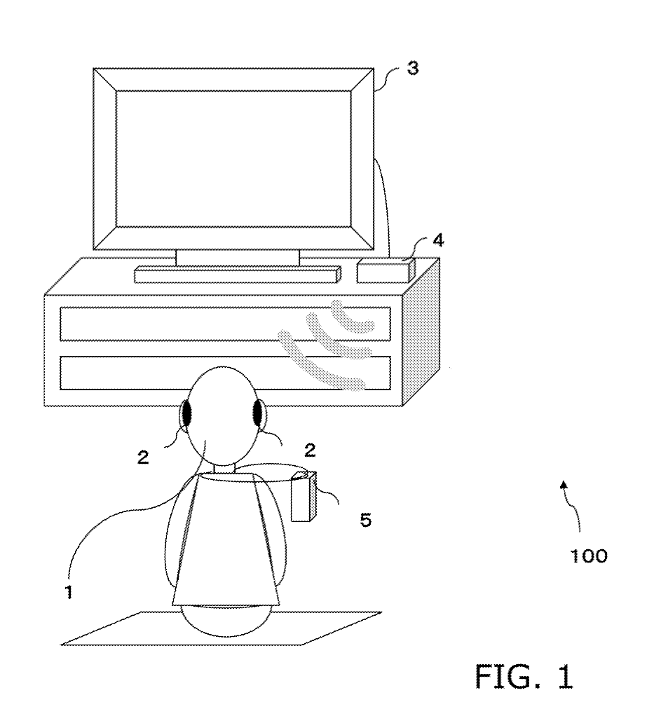

FIG. 1 shows the hearing aid device 100 pertaining to one embodiment of the present invention. The hearing aid device 100 comprises hearing aids 2, a wireless transmitter 4 (an example of a transmitter), and a relay S. The hearing aids 2 are mounted on the left and right ears of a user 1. The wireless transmitter 4 is connected to a television set 3 and placed in a position that allows communication with the relay 5. The relay 5 is able to communicate with the wireless transmitter 4, and is placed in a position that allows communication with the hearing aids 2. The relay 5 may, for example, he in a form that is mounted to the body of the user 1 by a neck strap or the like. The audio signal from the television set 3 is supplied via the wireless transmitter 4 and the relay 5 to the hearing aids 2 worn on the left and right ears of the user 1.

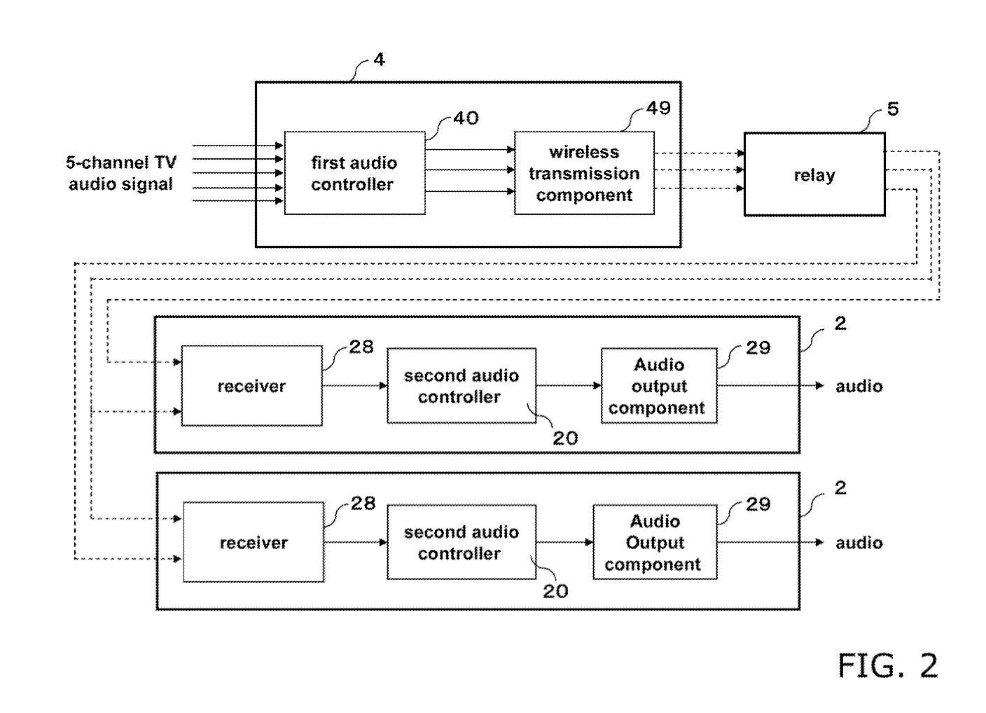

FIG. 2 is a control block diagram of the hearing aid device 100.

As shown in FIG. 2, the wireless transmitter 4 includes a first audio controller 40 and a wireless transmission component 49 (an example of a transmission component). The first audio controller 40 receives at least a five-channel signal consisting of a center signal (C), a left-front signal (L), a right-front signal (R), a left-rear signal (SL), and a right-rear signal (SR) from the television set 3. The wireless transmission component 49 is connected to the output side of the first audio controller 40, subjects the various signals that have undergone specific processing by the first audio controller 40 to specific modulation, and wirelessly sends them through an antenna (not shown) to the relay 5.

The relay 5 receives the output signal from the wireless transmitter 4, and wirelessly sends the received signal to the hearing aids 2.

As shown in FIG. 2, the hearing aids 2 each include a receiver 28 (an example of a receiver), a second audio controller 20, and an audio output component 29. The receiver 2$ receives and demodulates the output signal from the relay 5 via an antenna (not shown). The second audio controller 20 performs specific hearing aid processing (as discussed below) on the signal received by the receiver 28. The audio output component 29 is a speaker, for example, and outputs the sound from the second audio controller 20 to the ears of the user 1.

### 1.2 First Audio Controller 40

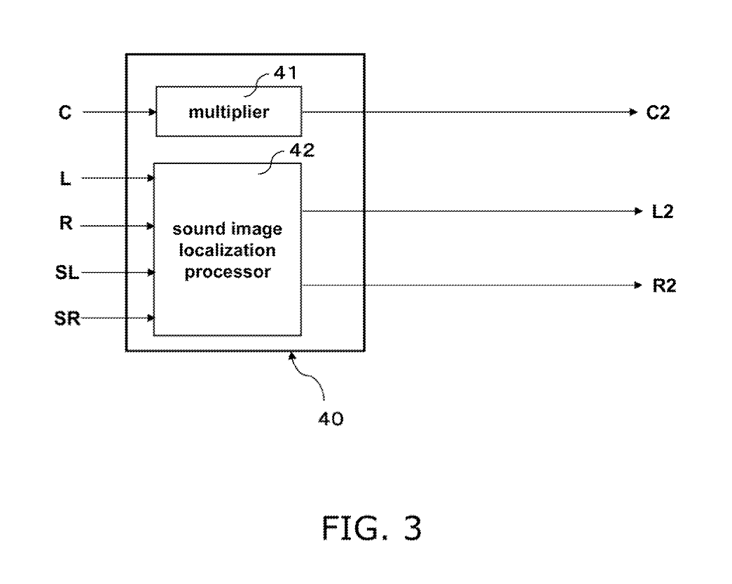

FIG. 3 is a simplified control block diagram of the first audio controller 40 of the wireless transmitter 4. The first audio controller 40 has a multiplier 41 (an example of a second amplifier) to which the center signal (C) is supplied, and a sound image localization processor 42 to which the left-front signal (L), the right-front signal (R), the left-rear signal (SL), and the right-rear signal (SR) are supplied. The multiplier 41 inputs the center signal (C) and amplifies it by a certain proportion. The sound image localization processor 42 receives the left-from signal (L), the right-front signal (R), the left-rear signal (SL), and the right-rear signal (SR), and performs sound distance control processing as discussed below, after which the product is outputted as a left-side signal (L2) and a right-side signal (R2).

### 1.3 Second Audio Controller 20

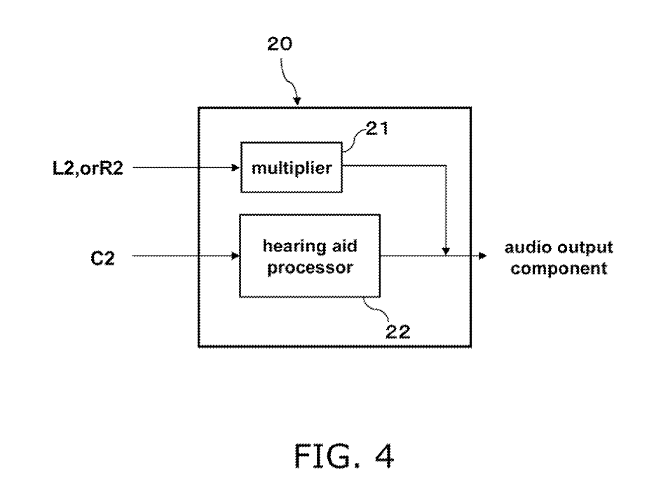

FIG. 4 is a simplified control block diagram of the second audio controller 20 of each of the hearing aids 2. The second audio controller 20 has a multiplier 21 (an example of a first amplifier) and a hearing aid processor 22. The multiplier 21 receives the left-side signal (L2) or the right-side signal (R2) from the sound image localization processor 42 of the first audio controller 40 of the wireless transmitter 4, and amplifies the signal by a specific proportion. The hearing aid processor 22 inputs the amplified center signal (C2) from the multiplier 41 of the first audio controller 40 of the wireless transmitter 4. The multiplier 21 may be omitted.

The hearing aid processor 22, for example, outputs and analyzes he strength at each frequency, which is obtained by Fourier transform, for the inputted center signal (C2), reads hearing aid parameters that have been stored in a memory (not shown) and set on the basis of the bearing ability of the hearing aid user, and performs amplification processing for each frequency. The hearing aid processor 22 also subjects the amplified signals to reverse Fourier transform processing.

In the above embodiment, the control blocks constituting the first audio controller 40 of the wireless transmitter 4 and the second audio controller 20 of the hearing aids 2 are programs that are operated by a CPU (central processing unit) or a memory.

### 1.4 Sound Image Localization Processing

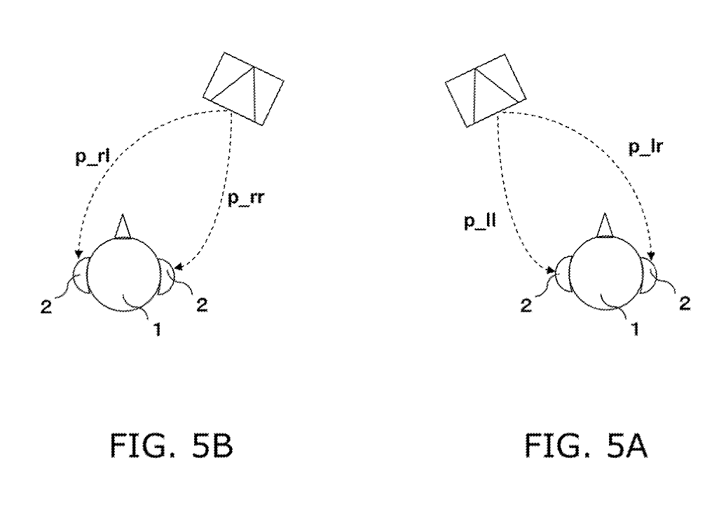

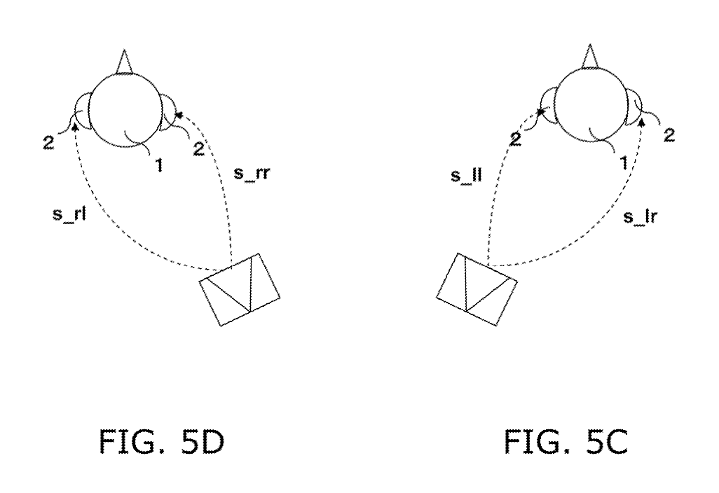

FIGS. 5A to 5D illustrate the sound distance control processing of ambient sounds by the sound image localization processor 42 of the first audio controller 40 of the wireless transmitter 4. FIG. 5A illustrates processing that allows the user 1 to hear the sound from the left front that is supposed to be heard from the left front. In the processing, a transmission function (p_ll, p_lr) to the left and right hearing aids 2 is calculated by convolution. FIG SB illustrates processing that allows the user I to hear the sound from the right front that is supposed to be heard from the right front. In the processing, a transmission function (p_rl, p_rr) to the left and right hearing aids 2 is calculated by convolution. FIG. 5C. illustrates processing that allows the user 1 to hear the sound from the left rear that is supposed to be heard from the left rear. In the processing, a transmission function (s_ll, s_lr) to the left and right hearing aids 2 is calculated by convolution. FIG. 5D illustrates processing that allows the user 1 to hear the sound from the right rear that is supposed to be heard from the right rear. In the processing, a transmission function (s_rl, s_rr) to the left and right hearing aids 2 is calculated by convolution. If these processing steps are not performed, the user will hear raw sound with no position information, so the sound will be heard as if it were located at the ear or inside the head. Performing sound image localization processing adds position information to the sound, so that the sound heard as if it were coming from the desired place, removed from the ear location.

The left-front signal (L), the right-front signal (R), the left-rear signal (SL), and the right-rear signal (SR) are merged by the sound image localization processor 42 so as to locate the sound image in a specific direction, and the result is outputted as the left-side signal (L2) and the right-side signal (R2). For example, the left-side signal (L2) and the right-side signal (R2) are produced as follows.

L2=p_{—}ll×L+p_{—}rl×R+s_{—}ll×SL+s_{—}rl×SR

R2=p_{—}lr×L+p_{—}rr×R+s_{—}lr×SR+s_{—}rr×SR

These techniques are known as surround-sound system techniques, and will not be described in detail here. in the above-mentioned convolution processing, the transmission function is calculated by convolution so that ambient sounds are heard as if they were coming from farther away to the front, rear, left, and right. This allows processing to he performed so that the user 1 hears only ambient sounds far away,

### 1.5 Example of Operation of Hearing Aid Device 100

For example, when the user is watching a soccer broadcast on the television set 3, the sound is processed as follows. The commentary of the announcer (conversation sound) is inputted as the center signal (C) from the television set 3 to the first audio controller 40 of the wireless transmitter 4. Meanwhile, other sounds, such as the noise of the crowd in the stadium and other such ambient sounds, is also inputted to the first audio controller 40 as the left-front signal (L), the right-front signal (R), the left-rear signal (SL), and the right-rear signal (SR). The center signal (C) is inputted to the multiplier 41 of the first audio controller 40, amplified by a specific proportion, and outputted as the center signal (C2). Meanwhile, the left-front signal (L), the right-front signal. (R), the left-rear signal (SL), and the right-rear signal (SR) are inputted to the sound image localization processor 42, subjected to sound distance control processing as discussed above, and then outputted as the left-side signal (L2) and the right-side signal (R2).

The center signal (C2) as conversation sound outputted by the multiplier 41 of the first audio controller 40 is inputted to the hearing aid processor 22 of the second audio controller 20 of each of the hearing aids 2, and subjected to specific signal processing as discussed above. Meanwhile, the left-side signal (L2) or the right-side signal (R2) outputted from the sound image localization processor 42 of the first audio controller 40 is inputted to the multiplier 21 of the second audio controller 20 and amplified by a specific proportion. The signal amplified by the multiplier 21 (first amplified audio signal) and the audio signal amplified by the hearing aid processor 22 (second amplified audio signal) are outputted as sound to the audio output component 29.

As discussed above, conversation sound is subjected to hearing aid processing by the hearing aid processor 22 in a state of being separated from ambient sounds, and therefore can be heard extremely clearly by the user 1. Meanwhile, the left-side signal (L2) and the right-side signal (R2) that have undergone sound distance control processing by the sound image localization processor 42 of the wireless transmitter 4 are inputted to the multiplier 21 of each of the hearing aids 2 and amplified. As a result, the user is also able to enjoy the ambient sounds fully. Specifically, to the user it seems as if what the announcer is saying can be clearly heard nearby, and the crowd noise in the stadium and other such ambient sounds can he heard far away. As a result, the user can enjoy a realistic feel to the broadcast.

As a comparative example to this embodiment, commentary of the announcer (conversation sound) is lost when the crowd noise in the stadium and other such ambient sounds are not subjected to sound distance control processing, as discussed above. Specifically, the hearing aid user perceives that the commentary of the announcer and the crowd noise in the stadium and other such ambient sounds can both be heard as if coming from the same place. As a result, the user cannot make out what the announcer is saving (conversation sound). Another approach to making it easier for the user to hear what the announcer is saying (conversation sound.) is to reduce just the ambient sounds, namely, to attenuate the left-front signal (L), the right-front signal (R), the left-rear signal (SL), and the right-rear signal (SR). This, however, does not afford aural realism. This is because soft sounds are extremely difficult to hear for a person with hearing impairment, so if the ambient sounds are merely reduced, those ambient sounds can barely be heard at all, so the user does not get the authentic feel of actually being there.

In this embodiment, the commentary of the announcer (conversation sound) as the center signal (C) is subjected to hearing aid processing by the hearing aid processor 22 of the hearing aids 2 in a state of being separated from the ambient sounds. Thus, the user 1 can hear the conversation sound extremely clearly in a state that matches his own hearing ability. Also, crowd noise in the stadium and other such ambient sounds as the left-front signal (L), the right-front signal (R), the left-rear signal (SL), and the right-rear signal (SR) are subjected to sound distance control processing by the sound image localization processor 42 of the wireless transmitter 4 after which it is amplified by being multiplied by the multiplier 21 of the hearing aids 2. Therefore, the user 1 can also enjoy ambient sounds fully, and as a result can enjoy the broadcast with a more realistic feel.

### 1.6 Features of Hearing Aid Device 100

With the hearing aid device 100 pertaining to this embodiment, the center signal (C) (conversation sound) is subjected to hearing aid processing by the hearing aid processor 22 of the hearing aids 2 in a state of being separated from the left-front signal (L), the right-front signal (R), the left-rear signal (SL), and the right-rear signal (SR) (ambient sounds), so the user 1 can hear conversation sound more easily. Also, since these ambient sounds are subjected to sound distance control processing by the sound image localization processor 42 of the wireless transmitter 4 so that they sound as if they are coming from a place far away from the center signal (C), conversation sound can he heard even more clearly. Also, after the sound distance control processing, the ambient sounds are amplified by being multiplied by the multiplier 21 of the hearing aids 2, so even as person with impaired hearing can feel as if he picks up ambient sounds very naturally. As a result, even a person with impaired hearing can easily hear conversation sound, and can enjoy watching a broadcast with a more realistic feel.

### 2. Other Embodiments

In the above embodiment, the various control blocks that made up the second audio controller 20 of the hearing aids 2 and the fast audio controller 40 of the wireless transmitter 4 were programs that are operated by a CPU (central processing unit) or a memory, but some or all of their functions may be accomplished instead by an integrated circuit such as an LSI (Large-Scale Integration) circuit.

Also, the relay 5 was provided in the above embodiment, but the present invention is not limited to this. The relay 5 may be omitted, so that the hearing aids 2 receive signals directly from the wireless transmitter 4.

The first audio controller was provided to the wireless transmitter 4 in the above embodiment, but may instead be provided to the hearing aids 2.

The transmission and receipt of signals between the relay S and the hearing aids 2 may be accomplished with wires.

The hearing aid device 100 was described in the above embodiment, but the present invention can also he realized as an audio control method.

### INDUSTRIAL APPLICABILITY

The present invention can be widely applied as a variety of hearing aid devices.

### REFERENCE SIGNS LIST

1 user
2 hearing aid
3 television set
4 wireless transmitter (an example of a transmitter)
5 relay
20 second audio controller
21 multiplier (an example of a first amplifier)
22 hearing aid processor
28 receiver (an example of a receiver)
29 audio output component
40 first audio controller
41 multiplier (an example of a second amplifier)
42 sound image localization processor
49 wireless transmission component (an example of a transmission component)

1. A hearing aid device that outputs sound on the basis of a plurality of audio signals, including at least a center signal, a left-front signal, a right-front signal, a left-rear signal, and a right-rear signal, said hearing aid device comprising:
a first audio controller configured to receive the center signal, the left-front signal, the right-front signal, the left-rear signal, and the right-rear signal; and
a second audio controller configured to receive an output signal from the first audio controller,
wherein the first audio controller has a sound image localization processor configured to locate a sound image in a specific direction with respect to the left-front signal, the right-front signal, the left-rear signal, and the right-rear signal, and
the second audio controller has a first amplifier configured to amplify an output signal from the sound image localization processor, and a hearing aid processor configured to amplify the center signal according to a hearing ability of a user of the hearing aid device, and the second audio controller outputs an output signal from the first amplifier and an output signal from the hearing aid processor as sound.

2. The hearing aid device according to claim 1,
wherein the first audio controller further has a second amplifier configured to amplify the center signal, and
the hearing aid processor of the second audio controller amplifies an output signal from the second amplifier according to the hearing ability of the user of the hearing aid device.

3. The hearing aid device according to claim 1,
further comprising a transmitter and a hearing aid,
wherein the transmitter includes the first audio controller and a transmission component configured to transmit the output signal from the first audio controller, and
the hearing aid includes a receiver configured to receive an output signal from the transmission component, and the second audio controller configured to receive the output signal from the first audio controller via the receiver.

4. The hearing aid device according to claim 3,
further comprising a relay configured to receive the output signal from the transmitter and transmits the output signal from the transmitter to the hearing aid.

5. The hearing aid device according to claim 1,
further comprising two hearing aids,
wherein the two hearing aids each include the second audio controller,
the sound image localization processor of the first audio controller outputs a left-side signal and a right-side signal by merging the left-front signal, the right-front signal, the left-rear signal, and the right-rear signal so as to locate a sound image in a specific direction, and
the two hearing aids input the left-side signal and the right-side signal, respectively.

6. The hearing aid device according to claim 1,
wherein the hearing aid processor of the second audio controller amplifies the center signal for each frequency using hearing aid parameters according to the hearing ability of the user.

7. The hearing aid device according to claim 1,
wherein the center signal is a conversation sound signal, and the left-front signal, the right-front signal, the left-rear signal, and the right-rear signal are audio signals excluding conversation sound.

8. An audio control method for outputting sound on the basis of a plurality of audio signals including at least a center signal, a left-front signal, right-front signal, a left-rear signal, and a right-rear signal, comprising:
locating a sound image in a specific direction with respect to the left-front signal, the right-front signal, the left-rear signal, and the right-rear signal;
producing a first amplified audio signal by amplifying a signal for which a sound image has been located in the specific direction;
producing a second amplified audio signal by amplifying the center signal according to the hearing ability of the user; and
outputting the first amplified audio signal and the second amplified audio signal as sound.
